(19) United States
(12) Patent Application Publication
(10) Pub. No.: US 2006/0136300 A1
(43) Pub. Date: Jun. 22, 2006

(54) Method and apparatus for promoting resale of foods

(75) Inventors: Joshua M. Kopelman, Gladwyne, PA (US); Srinivas Balijepalli, Philadelphia, PA (US)

Correspondence Address: SYNNESTVEDT & LECHNER, LLP, 2600 ARAMARK TOWER, 1101 MARKET STREET, PHILADELPHIA, PA, 191072950, US

(73) Assignee: eBay Inc., San Jose, CA (US)

(21) Appl. No.: 11/318,003

(22) Filed: Dec. 23, 2005

Related U.S. Application Data
(63) Continuation of application No. 09/428,078, filed on Oct. 27, 1999, now abandoned.

(51) Int. Cl. G06Q 30/00

(52) U.S. Cl. 705/14

(57) ABSTRACT

A method for promoting resale of goods. The method includes solicitation of agreement to offer a good for resale from a buyer of the good near the time of the sale, near the time of confirmation of a desire to purchase a good and/or subsequent to the time of the sale. The buyer may agree to offer the good for resale at a specified future time or upon occurrence of a trigger event. Alternatively, the buyer may agree to be solicited at a future time. Additionally, a relisting agent may solicit the buyer subsequent to the time of sale upon occurrence of a trigger event. A seller, a marketeer, etc. may act as the relisting agent. In electronic commerce applications, a software-implemented relisting controller is used to solicit agreement from buyers to offer the good for resale. An apparatus for performing a computer-implemented version of the inventive method is provided.

### CROSS-REFERENCE TO RELATED APPLICATION

This application is a continuation of U.S. application Ser. No. 09/428,078, filed Oct. 27, 1999, the entire disclosure of which is hereby incorporated herein by reference.

### FIELD OF THE INVENTION

This invention relates generally to the field of sales of goods and particularly to a method and apparatus for promoting resale of goods in electronic commerce applications using communications networks.

### BACKGROUND OF THE INVENTION

The industrial age has given rise to a global economy of factories engaged in mass production of various goods. An enormous amount of commerce is transacted in the buying and selling of such goods. While some such goods lose their value with use, e.g., food products, many such goods retain a substantial portion of their value even after use or ownership by another. Such goods are referred to herein as “durable”. A considerable amount of commerce is transacted in the buying and selling of durable goods.

Almost all durable goods are readily identifiable by a standard unique identification code (“ID code”), particularly those that are mass produced. In the case of computer software, music cassettes or compact discs, videocassettes and digital video discs, the ID code may be a human readable Universal Product Code (“UPC”), a thirteen digit ID code that readily identifies the good. In the case of books, magazines or other publications, the ID code may be a ten-digit International Standard Book Number (“ISBN”). Other items are more readily identified by a manufacturer or brand name and a model number, as for baseball cards and consumer electronics, e.g., a Sony® KV-3620 television. Some goods may have more than one type of ID code although any one of them is sufficient to uniquely identify the good.

Many durable and readily identifiable goods are fungible items that derive their value substantially from their common characteristics. For example, a single signed copy of Michael Jackson's album titled “Thriller” and recorded on a compact disc (“CD”) derives much of its value because it is signed by the performance artist. Such a CD is unique and therefore is not a fungible good. In contrast, an unsigned copy of Michael Jackson's “Thriller” CD derives substantially all of its value because of the songs recorded thereon. Therefore, all such CD's have substantially the same value to consumers. Such CD's are therefore fungible.

Retail selling provides a marketplace for sale of goods. However, it requires the seller to maintain a large inventory of goods for sale. The size of such an inventory is typically limited to the amount of inventory the seller can afford to carry. In addition to sales at traditional stores, retail selling is conducted at numerous online websites, such as www.amazon.com. Online retail selling also requires the seller to maintain a large inventory of goods.

Auctions also provide a marketplace for sale of goods. In a traditional auction house, an auctioneer facilitates sales of goods without the need to maintain an inventory of his own. While this is advantageous in some respects, it results in a dependency upon third party owners of goods. Auctions, by their nature, are subject to a limited availability of goods for sale. Numerous online auctions may be found. An example of an online auction is held by eBay Inc. of San Jose, Calif., on the worldwide web at www.ebay.com.

U.S. application Ser. No. 09/427,958, attorney docket number P23305 USA, filed concurrently herewith, now U.S. Pat. No. ______, describes an advantageous method and apparatus for facilitating sales of goods owned by independent parties. The facilitator is an intermediary referred to as a marketeer. Like an auctioneer, the marketeer presents goods for sale in a marketplace under his control. Unlike an auctioneer, the marketeer determines the price for the independent seller's good using a predetermined method for deriving a sale price from an index price for a comparable good. The marketeer advantageously does not physically receive any goods into inventory. Therefore, the marketeer is also dependent upon third party owners of goods and subject to a limited availability of goods for sale.

Until now, there has been no acceptable way to enhance the availability of goods for sale.

Accordingly, it is an object of the present invention to enhance the availability of goods for sale by providing a method for promoting repeated sales of a good.

It is another object of the present invention to provide a method for soliciting, near the time a buyer confirms his desire to purchase a good, an agreement to offer the good for resale at a future time.

It is another object of the present invention to provide a method for soliciting, responsive to a trigger event subsequent to the time a good is purchased by a buyer, an agreement to offer the good for resale.

It is yet another object of the present invention to provide a method for promoting resale of a good at a future time chosen by the buyer.

It is a further object of the present invention to provide a method for promoting resale of a good offered for sale by an independent seller.

It is yet a further object to provide an apparatus for promoting resale of goods.

It is yet a further object of the present invention to provide a computer-implemented method for promoting resale of goods.

### SUMMARY OF THE INVENTION

The invention provides a method for facilitating resale of goods by soliciting from a buyer an agreement to offer the good for resale. The solicitation may be made near the time of the sale or after the time of sale. If the solicitation is to be made after the sale, the time may be predetermined or the buyer may specify a fixed time interval or a trigger event after which he would like to be solicited to resell the book.

### DESCRIPTION OF THE DRAWINGS

FIG. 1 is a flow diagram providing an overview of a method for promoting resale of a good in accordance with the present invention;

FIG. 2 is a flow diagram providing an example of a method for promoting resale of a good by a vendor of the good; and

FIG. 3 is a block diagram of a relisting controller in accordance with the present invention; and

FIG. 4 is a flow diagram providing an example of a method for promoting resale of a good via a marketeer who facilitates sale of a good by an independent seller.

### DETAILED DESCRIPTION

The present invention provides a method and apparatus for promoting resale of goods. Accordingly, the invention is particularly advantageous for use with durable goods which retain most of their value even after a first purchase and/or use. In the preferred embodiment, the invention is computer-implemented in a fashion to exploit the fungible and readily-identifiable nature of many durable goods.

Traditional sellers, traditional auctioneers, and marketeers, as described in U.S. application Ser. No. 09/427,958, attorney docket number P23305 USA, filed concurrently herewith, now U.S. Pat. No. ______, the disclosure of which is hereby incorporated by reference, receive revenues primarily when a sale transaction takes place. For example, a seller may directly profit from the sale at a price higher then that paid for the good while the auctioneer and marketeer may receive a fixed fee or a percentage of the sale price. Accordingly, sellers, auctioneers and marketeers desire to increase the number of sale transactions to increase their revenues.

The present invention provides a method and apparatus for increasing the number of sale transactions by enhancing the availability of goods for sale by promoting resale of goods. The present invention is preferably computer-implemented, although it need not be. In either case, the present invention provides a method whereby a buyer desiring to purchase a good is solicited to agree to offer to resell the good. The method could be implemented in numerous ways.

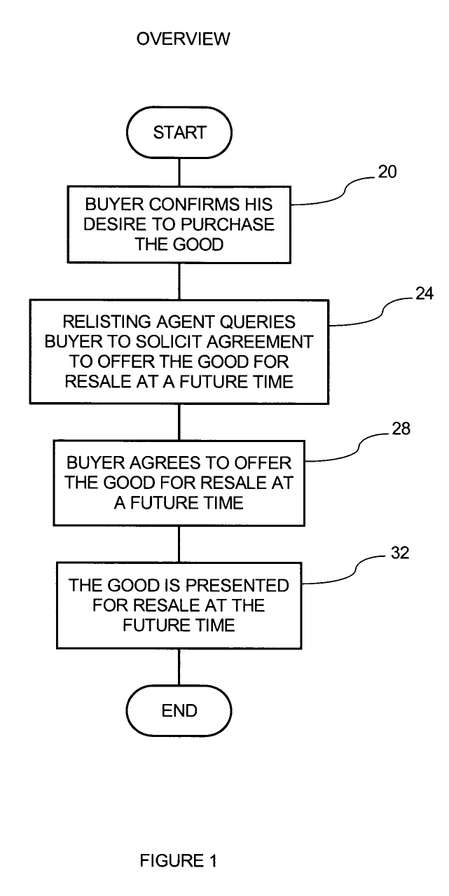

FIG. 1 is a flow diagram providing an overview of a transaction in accordance with the present invention. A buyer first browses goods for sale in a marketplace and selects a good he desires to purchase. The buyer then confirms his desire to purchase the good, as shown at step 20. A buyer may confirm his desire by actually purchasing the good, e.g., when dealing with a seller, or by simply expressing his desire to proceed with the sale transaction, e.g., by displaying a numbered card in the case of an auction.

A relisting agent, i.e., a seller, auctioneer or marketeer, then queries the buyer to solicit the buyer's agreement to offer the good for resale at a future time, as shown at step 24. The solicitation of agreement to offer the good for resale could take a variety of forms. For example, in the case of a seller intending to sell a good to the buyer, the seller may seek agreement from the buyer to resell the good to the seller so that the seller may place the good in its inventory and then attempt to resell the good to another buyer. In the case of an auctioneer or marketeer, for example, who facilitates sale of an independent seller's good, agreement may be sought from the buyer to permit the auctioneer or marketeer to present the good in its marketplace for resale by the buyer.

The future time could be specified by the buyer, e.g., by specifying a date certain or by selecting a method for determining a date certain. Alternatively, the future time can be set by the relisting agent. Alternatively, the future time could be determined as a function of a trigger event identified by either the buyer or the relisting agent. In the preferred embodiment, the buyer's agreement to offer the good for resale is solicited near the time when the buyer confirms his desire to purchase the good. The buyer is preferably presented with an incentive to agree to offer the good for resale, e.g., the opportunity to purchase at a discounted price the good he desires. Alternatively, the buyer may be permitted to request a reminder, i.e., another solicitation in the future time, as discussed above. For example, a buyer could request to be solicited to resell author Sue Grafton's book titled “A is for Alibi” after release of her subsequent book, e.g., “B is for Burglar”, release of the subsequent book being the trigger event.

If the buyer does not agree, he is preferably solicited again after a trigger event selected by the relisting agent. The trigger event could be passage of a specified amount of time or release of a related good, e.g., an author's next book. While the buyer may specify a resale price for the good, it is preferable that the relisting agent determine the resale price.

If the buyer agrees to offer the good for resale at a future time, the good is later presented for resale at the future time, as shown at steps 28 and 32. In one embodiment, a seller acts as the relisting agent in step 24 and also presents the good for resale in step 32. Alternatively, a seller may act as the relisting agent in step 24 and another party may present the good for resale in step 32. For example, the seller could communicate information about the good to another party, such as an auctioneer or marketeer, for presentation of the good for resale. This may be advantageous, for example, if the seller chooses to sell only new goods. In the preferred embodiment, a marketeer acts as the relisting agent in step 24 and presents the good for resale by the buyer in step 32. In the preferred embodiment, the marketeer determines the resale price for the good. U.S. application Ser. No. 09/427,958, attorney docket number P23305 USA, filed concurrently herewith, now U.S. Pat. No. ______ describes a suitable method and apparatus for facilitating sale of and pricing an independent seller's good. In broad terms, that method includes steps of receiving a buyer's interest in purchasing a good, identifying an index price of a comparable good and deriving a sale price for the good from the index price using a predetermined method. The method and the apparatus are described in more detail in U.S. application Ser. No. 09/427,958.

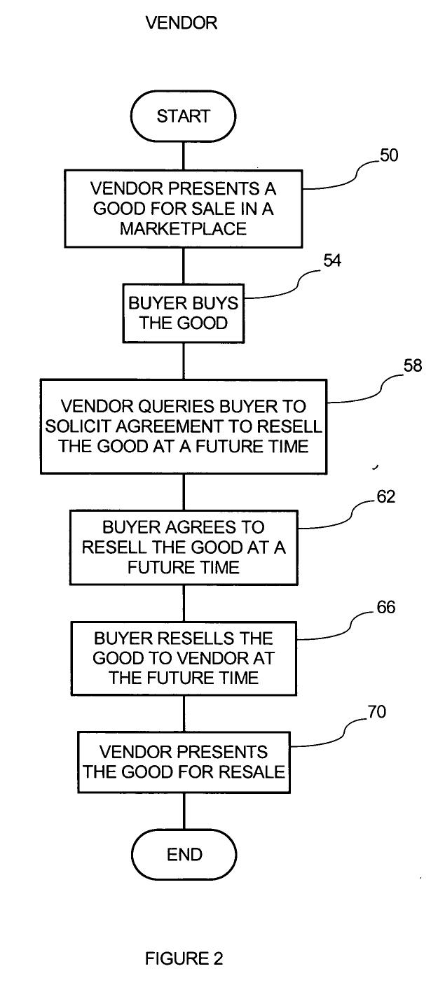

FIG. 2 is a flow diagram of an example of a transaction in accordance with the present invention where a commercial seller, or “vendor”, is the relisting agent. The vendor first presents a good he holds in inventory for sale in a marketplace under his control, as shown at step 50. The buyer may browse the marketplace and select the good. He then confirms his desire to purchase the good by buying the good from the vendor, as shown at step 54. The vendor then queries the buyer, responsive to step 54, to solicit an agreement to resell the good as shown at step 58. In an alternate embodiment, step 58 could occur a significant time after step 54, e.g., after a trigger event. The vendor's query and/or the buyer's agreement to resell the good includes a reference to a future time at which the good is to be resold or offered for resale. In this example, the future time is specified by the vendor by querying the buyer “Do you agree to offer the good for resale to [vendor] on a date 30 days from today?” In this example, the buyer agrees to resell the good at a future time and the vendor buys the good back from the buyer at the future time, as shown at steps 62 and 66. Finally, the vendor presents the good for resale, in its marketplace, as shown at step 70.

This method provides the vendor with more goods and a broader range of goods to sell, e.g., both new and used goods. In addition, by seeking agreement from the buyer near the time of the buyer confirms his desire to purchase the good, the vendor can provide incentives to the buyer to encourage him to make such an agreement. Furthermore, receiving an agreement to offer the good for resale at a particular future time assists the vendor in managing his inventory and planning his future purchases to stock his inventory. Even if the buyer does make such an agreement at the time of the sale, the buyer may agree to receiving a reminder or a subsequent solicitation for an agreement to offer the good for resale at a future time. Alternatively, the vendor may query the buyer after a trigger event of vendor's choosing. These approaches provide the vendor with another opportunity to receive the good for resale.

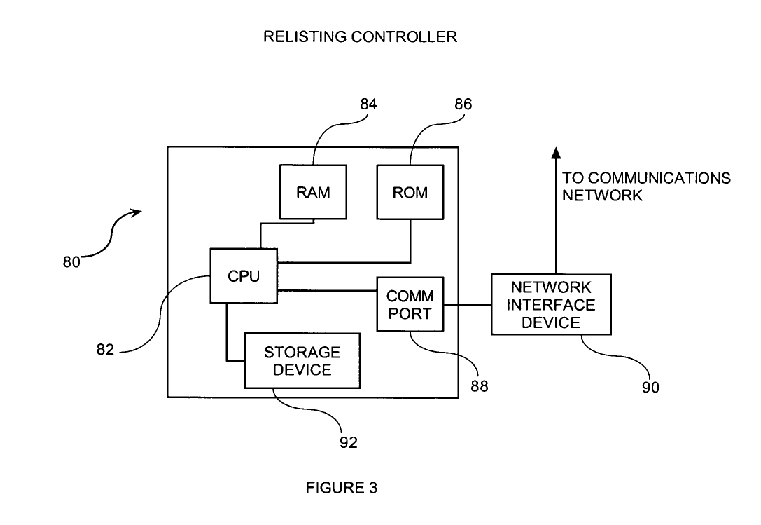

In the preferred embodiment, a marketeer acts as the relisting agent, the marketeer offers the good for resale, and the method is computer implemented. A block diagram of a relisting controller for implementing the method is shown in FIG. 3. The relisting controller 80 has a clocked central processing unit (“CPU”) 82 for executing computer programs. The relisting controller also has a read only memory (“ROM”) 84 for storing at least some of the program instructions that are to be processed by the CPU, and a random access memory (“RAM”) 86 for temporary storage of data. Use of a clocked CPU in conjunction with a RAM and a ROM is well known to those in the art of CPU-based electronic circuit design.

The relisting controller also includes a communication port (“COMM PORT”) 88 which enables the CPU to communicate with devices external to the relisting controller, particularly, a network interface device 90, so that information received via the network interface device 90 can be processed by the CPU and the CPU can send information to the communications network via the network interface device 90. In the preferred embodiment, the network interface device 90 comprises a modem. However, in other embodiments, the network interface device could include a network card, a hard-wired connection, radio communication equipment, optical communication equipment, or similar equipment and could be internal to the relisting controller. The relisting controller also includes a storage device 92 to which the CPU can store data and from which the CPU can read data. The relisting controller is configured for communication with a buyer interface, e.g., a buyer's computer running standard web browser software, as is well known in the art.

The relisting controller stores in its memory, i.e., RAM, ROM, or storage device, a first program for receiving via a communications network data confirming a buyer's desire to purchase a good, a second program for soliciting agreement from the buyer to offer the good for resale at a future time, and a third program for storing data identifying the good. Preferably, the third program is further configured to store data identifying the buyer and the future time and to do so responsive to receipt of a buyer's agreement to offer the good for resale. In the preferred embodiment, the relisting controller also stores in its memory a fourth program for communicating data identifying the good, the buyer, and the future time to the marketeer controller. Several or all of these programs may be integrated into a single layer program. In one embodiment, the buyer may specify a resale price for the good, the third program stores the resale price, and the fourth program transmits the resale price to the marketeer controller.

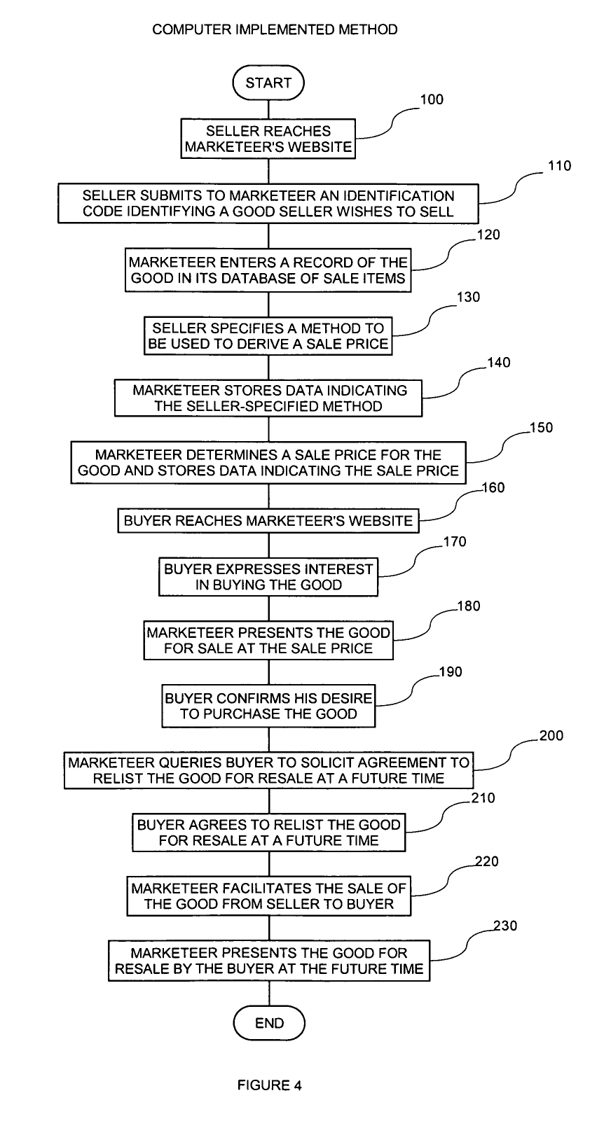

FIG. 4 is a flow diagram providing an example of a computer-implemented transaction in accordance with the present invention. In this example, the marketeer operates a marketeer controller for presenting goods for sale in a marketplace, e.g., a website. In one embodiment, the marketeer controller also determines the resale price for the good in accordance with a method described in U.S. application Ser. No. 09/427,958, attorney docket number P23305 USA, filed concurrently herewith, now U.S. Pat. No. ______. As described in detail in U.S. application Ser. No. 09/427,958, the marketeer controller is a computer storing specialized computer programs for receiving information identifying goods from sellers and for pricing the goods. The marketeer controller is connected to a communications network and is accessible to buyers and sellers. In general, the marketeer controller stores in its memory a first program for receiving and storing identification code data from a seller to identify a good, a second program for receiving data indicating a buyer's interest in purchasing the good, and a program for deriving a sale price of the good from an index price using a predetermined method. In this example, the marketeer also operates the relisting controller for processing data for relisting a good for resale.

As shown in FIG. 4, a seller first reaches the marketeer's website, as shown at step 100. In effect, the seller is entering the marketeer's virtual marketplace. A seller may do so by visiting the marketeer's website using his personal computer to access the marketeer controller via the communications network. The seller then identifies to the marketeer a good he wishes to sell, in effect, registering or “listing” the good for sale with the marketeer. To do so, the seller submits a standard identification code to the marketeer, as shown at step 110. This may be achieved by the seller using his keyboard to enter the code into a field provided by the marketeer's website, as is known in the art. The standard identification code may be a universal product code (UPC) or a International Standard Book Number (ISBN), for example. The use of a standard identification code identifies the good in a manner readily identifiable by the marketeer and/or buyers.

The marketeer controller stores the identification code in its memory to register the good as an item listed for sale by the seller, as shown at step 120. The marketeer controller may also store in its memory data provided by the seller to identify the seller as the owner of the good.

In this example, the seller does not specify a price but rather specifies a method for deriving a sale price from an index price, as shown at step 130. For example, the method could include a discount from a manufacturer's list price. In the preferred embodiment, the seller specifies a method including a discount from a price of a comparable new good by a certain percentage. This may be achieved, for example, by the seller's selection of an option from a menu presented by the marketeer, e.g., by selecting a button or check-box using his mouse, as is well known in the art. For example, the marketeer may present a menu of options for a 70% discount from a manufacturer's suggested retail price, a 70% discount from a price for a comparable new good, a 50% discount from a manufacturer's suggested retail price, or a 50% discount from a price for a comparable new good. The marketeer controller also stores in its memory data indicating the method specified by the seller for pricing the good, as shown at step 140.

The marketeer controller next determines a sale price for the good, as shown at step 150. For example, the marketeer may consult a database to determine a fixed price set by the seller. Alternatively, the marketeer may consult a database of list prices and information identifying a discount set by the seller and derive a price by applying the discount to the list. In yet another embodiment, the marketeer determines an index price for the good by querying multiple third party vendors of comparable goods to determine their respective prices and equating the index price to the lowest price of a group of third party vendors for a new good similar to the used good offered for sale by the seller. The querying step is performed by a shopping agent program stored in the memory of the marketeer controller. In this embodiment, the marketeer then derives a sale price of the good from the index price using the method specified by the seller. This is performed by a pricing agent program stored in the memory of the marketeer controller. For example, the method may include a discount of the index price by fifty percent to determine the sale price of the seller's good.

At this point, the good is listed with the marketeer for sale by the seller and is therefore presented for sale by the marketeer. The marketeer has not taken possession of the good.

After a period of time, a buyer enters the marketeer's marketplace by reaching the marketeer's website, as shown at step 160, using his personal computer to communicate with the marketeer controller via the communications network. The buyer may browse the marketeer's website to shop for a good. Presentation of electronic storefronts, including browsing and searching abilities is well known in the art. For example, books, music, and videos may be categorized by content or genre. Alternatively, for example, a buyer interested in a particular book may search by subject, author or title, and view an image of the cover of the book, read a description or review of the book, etc. In another embodiment, a buyer could search for an item using its standard unique ID code. Any method of categorizing, cataloging or searching may be used which enables a potential buyer to find a good for which he is looking or in which he may be interested. Goods in addition to those listed or registered for sale by sellers at the marketeer's website may be presented by the marketeer for browsing by a buyer. In one embodiment, the marketeer refers the buyer to a third party vendor if the good sought by the buyer is not listed for sale with the marketeer, e.g., by presenting a link to the vendor's website.

If the buyer is interested in the possibility of purchasing a good, the buyer expresses interest in buying the good, as shown at step 170. The buyer may do so using any suitable method, as are well known in the art. For example, a buyer may use his mouse to select a button or click a checkbox displayed on a web page and appearing on his video monitor.

The marketeer controller then presents the good to the buyer for sale at the sale price, as shown at step 180. This may be achieved by transmitting to the buyer via the communications network data for displaying the sale price and a description of the good on the video monitor of the buyer's personal computer.

If the buyer decides to purchase the good at the sale price, he confirms his intent to do so, as shown at step 190, in a manner similar to that described above with reference to expression of his interest in purchasing the good. Data confirming his desire to purchase the good at the sale price is received by the relisting controller. In one embodiment, the marketeer controller and relisting controller is integrated into a single computer.

The relisting controller then queries the buyer to solicit agreement to offer the good for resale at a future time, as shown at step 200. The query may be performed at the time the buyer confirms his desire to purchase a good, i.e., before or after the he confirms his desire but generally during the same transaction and/or communications session. In effect, the marketeer is soliciting the buyer's agreement to have the good relisted as a good for resale. The marketeer controller already stored the unique ID code identifying the good and the data identifying the seller of the good in step 120. If the buyer agrees to relist the good for resale at a future time, as shown at step 210, the relisting controller may receive the ID code from the marketeer controller and store it, store data indicating the future time, and store data indicating that the good is no longer for sale by the seller, will not be for sale until the future time, and that, at the future time, the good will be offered for sale by the buyer. Accordingly, data identifying the good is stored by the relisting controller and relisted for sale at a future time. The time could be determined by the marketeer, the buyer could specify a date certain, e.g., December 3, or the buyer could select an option to relist the good as a good for sale by the buyer a specified time period from the current date, e.g., in two months. The future time may be determined in any suitable manner.

The marketeer then facilitates the sale of the good from the seller to the buyer as shown at step 220. This may be achieved in any suitable manner. For example, the marketeer may facilitate the sale by identifying the seller to the buyer and the buyer to the seller, by referring the buyer and seller to an intermediary clearinghouse or escrow agent for receiving the good from the seller and payment from the buyer and then shipping the good to the buyer and providing payment to the seller. This could be performed by the marketeer controller, for example. Alternatively, the marketeer could act as the intermediary clearinghouse or escrow agent or refer the buyer and seller to such a clearinghouse or escrow agent.

Finally, the marketeer presents the good for resale by the buyer at the future time, as shown at step 230. The relisting controller preferably stores a program for automatically relisting the good for resale at the future time. This may include modification of the record stored in step 120 to identify the buyer as the seller of the good.

Preferably, the marketeer controller presents in its storefront numerous goods. The marketeer controller may present some goods for browsing which are not currently being offered for sale by a seller known to the marketeer. For example, the marketeer controller may store a database of all books published by a single publisher and present all such books in its marketplace, regardless of whether a seller has registered each of those books for sale with the marketeer. A prospective buyer may browse the marketeer's marketplace and find information relating to goods. If a good selected by the buyer is currently being offered for sale by a seller, i.e., a seller has listed that same good for sale with the marketeer controller and the good has not been sold to another buyer, a buyer confirming his desire to purchase the good will be matched with the seller by the marketeer and the marketeer will facilitate the sale transaction. If the buyer selects a good which no seller has listed for sale with the marketeer, or a good which has been previously listed for sale with the marketeer and subsequently sold to another buyer and is therefore not presently available for sale, the marketeer controller may optionally direct the prospective buyer to another vendor of the good, as discussed above.

In accordance with the present invention, the marketeer may offer many goods for sale, including goods for resale. The marketeer may thereby receive revenues by selling the same good multiple times. The computer-implemented method described above works particularly well for readily-identifiable, fungible, durable goods which have been pre-owned or used since the goods are readily identified by both the buyer and the seller and all goods offer similar value to the consumer. Further, the fact that the good has been used does not significantly deplete the value of the good to the consumer.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention.

Accordingly, the foregoing description is by way of example only, and not limiting. The invention is limited only as defined in the following claims and equivalents thereto.

1-34. (canceled)

35. A computer-implemented method for promoting resale of a seller's good, the method comprising a computerized marketeer party communicating via a computerized communications interface to:
confirm a buyer's desire to purchase the good;
solicit the buyer to agree to offer the good for resale;
present to the buyer an incentive for agreeing to offer the good for resale;
receive the buyer's agreement to offer the good for resale;
facilitate sale of the good from the seller to the buyer to complete a sale transaction; and
present the good for resale, the good being offered for resale by the buyer;
wherein the marketeer party acts as an intermediary between the buyer and a seller.

36. The method of claim 35, wherein confirming the buyer's desire to purchase the good is performed responsive to a buyer's interaction with a web page displayed on a video monitor.

37. The method of claim 36, wherein the buyer's interaction to confirm the buyer's desire to purchase the good is performed during a computerized communications session, and wherein soliciting the buyer to agree to offer the good for resale is performed during the same communications session.

38. The method of claim 36, wherein the buyer's interaction to confirm the buyer's desire to purchase the good is performed during a computerized communications session, and wherein soliciting the buyer to agree to offer the good for resale is performed after an end of the communications session.

39. The method of claim 38, wherein the buyer is solicited subsequent to a trigger event indicating that the buyer may be willing to offer the good for resale.

40. The method of claim 39, wherein the trigger event is passage of a fixed period of time.

41. The method of claim 40, wherein the fixed period of time is selected by the buyer.

42. The method of claim 40, wherein the fixed period of time is selected by a relisting agent.

43. The method of claim 39, wherein the trigger event is release for sale of a good related to the good purchased by the buyer.

44. The method of claim 35, wherein confirming the buyer's desire to purchase the good is performed responsive to a buyer's selection of a web page button displayed on a video monitor.

45. The method of claim 35, wherein soliciting the buyer to agree to offer the good for resale is performed by a computerized relisting controller.

46. The method of claim 45, wherein soliciting the buyer to agree to offer the good for resale is performed by displaying text on a video monitor of the buyer's personal computer.

47. The method of claim 45, wherein soliciting the buyer to agree to offer the good for resale is performed by displaying text via web browser software.

48. The method of claim 35, wherein the incentive is displayed to the buyer via a video monitor of the buyer's personal computer.

49. The method of claim 48, wherein the incentive comprises an opportunity to purchase the good at a discounted price, and wherein sale of the good is facilitated at the discounted price.

50. The method of claim 49, wherein the discounted price reflects a discount that is applied only if the buyer agrees to offer the good for resale.

51. The method of claim 48, wherein the incentive for agreeing to offer the good for resale is awarded only if the buyer agrees to offer the good for resale.

52. The method of claim 48, wherein the good may be purchased by the buyer at a price, and wherein the incentive comprises an opportunity to purchase the good at a discounted price only if the buyer agrees to offer the good for sale, and wherein sale of the good is facilitated at the discounted price.

53. The method of claim 35, wherein receiving the buyer's agreement to offer the good for resale is performed responsive to a buyer's interaction with a web page displayed on a video monitor.

54. The method of claim 35, further comprising:
receiving from the seller a standard identification code identifying the good, said standard identification code comprising a UPC code.

55. The method of claim 35, further comprising:
receiving from the seller a standard identification code identifying the good, said standard identification code comprising an ISBN code.

56. A controller for processing data for promoting resale of a seller's good, comprising:
a central processing unit (CPU);
a memory operatively connected to the CPU;
a network interface device operatively connected to the CPU for communicating with a buyer interface via a communications network; and
instructions stored in the memory and executable by the CPU to carry out the method of claim 35.

57. A method for promoting resale of a seller's good, the method comprising a computerized marketeer party:
facilitating sale of the good from the seller to a buyer to cause the buyer to take physical possession of the good;
querying the buyer, at a future time after the buyer has taken physical possession of the good, to solicit the buyer's agreement to offer the good for resale;
receiving the buyer's agreement to offer the good for resale; and
adding the good to an inventory of goods for sale, the good being offered for resale by the buyer.

58. The method of claim 57, further comprising:
presenting the good for sale, the good being offered for sale by the seller.

59. The method of claim 58, wherein adding the good to the inventory of goods for sale comprises storing data indicating that the buyer has agreed to offer the good for resale.

60. The method of claim 59, further comprising:
receiving from the seller a standard identification code identifying the good, said standard identification code comprising a UPC code.

61. The method of claim 60, further comprising:
receiving from the seller a standard identification code identifying the good, said standard identification code comprising an ISBN code.

62. A method for promoting resale of a good, the method comprising a computerized marketeer party:
facilitating sale of the good from a seller to a buyer to complete a sale transaction;
at a future time after the buyer has taken physical possession of the good, soliciting agreement from the buyer to offer the good for resale, the future time being a time after elapse of a period of time selected by the buyer;
receiving the buyer's agreement to offer the good for resale; and
presenting the good for resale, the good being offered for resale by the buyer.

63. The method of claim 62, wherein soliciting agreement from the buyer to offer the good for resale is performed by a computerized relisting controller.

64. The method of claim 63, wherein soliciting agreement from the buyer to offer the good for resale is performed by displaying text on a video monitor of the buyer's personal computer.

65. The method of claim 63, wherein soliciting agreement from the buyer to offer the good for resale is performed by displaying text via web browser software.

66. The method of claim 62, further comprising:
adding the good to an inventory of goods for sale, the good being offered for resale by the buyer; and
modifying the inventory of goods for sale to identify the good as being offered for resale by the buyer.

67. The method of claim 62, further comprising:
receiving from the seller a standard identification code identifying the good, said standard identification code comprising a UPC code.

68. The method of claim 62, further comprising:
receiving from the seller a standard identification code identifying the good, said standard identification code comprising an ISBN code.
